(19) United States
(12) Patent Application Publication
(10) Pub. No.: US 2025/0190690 A1
(43) Pub. Date: Jun. 12, 2025

(54) MERGING TEXT BLOCKS

(71) Applicant: MYSCRIPT, Nantes Cedex 3 (FR)

(72) Inventors: Thibault DESCHAMPS, Nantes Cedex 3 (FR); Romain BEDNAROWICZ, Nantes Cedex 3 (FR)

(21) Appl. No.: 18/846,253

(22) PCT Filed: Mar. 13, 2023
(86) PCT No.: PCT/EP2023/056296

§ 371 Date: Sep. 12, 2024

(30) Foreign Application Priority Data
Mar. 11, 2022 (EP) 22161593.3

(51) Int. Cl. G06F 40/174; G06F 3/04842; G06F 3/0486; G06F 40/117; G06F 40/171; G06V 30/32

(52) U.S. Cl. CPC G06F 40/174; G06F 3/04842; G06F 3/0486; G06F 40/117; G06F 40/171; G06V 30/36

(57) ABSTRACT

Method and devices for merging, text blocks are disclosed. Source blocks enclosing first input texts and target blocks enclosing second input texts are displayed. User selection gestures for selecting the source blocks are detected. User dragging gestures for moving the source blocks over the target blocks are detected. Switching to an insertion dropping mode including displaying a cursor in the source blocks is performed. Insertion positions in the second input texts indicated by the cursor of the source blocks according to the user dragging gestures are detected. First input texts are inserted in the second input texts at the insertion positions. Finally, the target block are resized to enclose the first input texts of the source blocks and the second input texts of the target blocks.

### FIELD OF THE INVENTION

The present disclosure relates generally to the field of computing device interfaces capable of interacting with, editing text block sections and handwriting recognition. In particular, the present disclosure relates to merging text blocks.

### BACKGROUND

Computing devices continue to become more ubiquitous to daily life. They take the form of computer desktops, laptop computers, tablet computers, hybrid computers (2-in-1s), e-book readers, mobile phones, smartphones, wearable computers (including smartwatches, smart glasses/headsets), global positioning system (GPS) units, enterprise digital assistants (EDAs), personal digital assistants (PDAs), game consoles, and the like. Further, computing devices are being incorporated into vehicles and equipment, such as cars, trucks, farm equipment, manufacturing equipment, building environment control (e.g., lighting, HVAC), and home and commercial appliances.

Computing devices generally comprise at least one processing element, such as a central processing unit (CPU), some form of memory, and input and output devices. The variety of computing devices and their subsequent uses necessitate a variety of interfaces and input devices. One such input device is a touch sensitive surface such as a touch screen or touch pad wherein user input is received through contact between the user's finger or an instrument such as a pen or stylus and the touch sensitive surface. Another input device is an input surface that senses gestures made by a user above the input surface. A further input device is a position detection system which detects the relative position of either touch or non-touch interactions with a non-touch physical or virtual surface. Any of these methods of input can be used generally for drawing or inputting text. The user's handwriting is interpreted using a handwriting recognition system or method.

There are many applications of handwriting recognition in portable computing devices, such as smartphones, phablets and tablets, such as is in note taking, document annotation, mathematical equation input and calculation, music symbol input, sketching and drawing, etc. Handwriting may also be input to non-portable computing devices, particularly with the increasing availability of touchscreen monitors for desktop computers and interactive whiteboards. These types of input are usually performed by the user launching a handwriting input application on the computing device which accepts and interprets, either locally in the device or remotely via a communications link of the device, handwritten input on the touch sensitive surface and displays or otherwise renders this input as so-called ‘digital ink’. Conventionally such handwriting input applications are limited in their capabilities to provide a full document creation experience to users from the text and non-text (e.g., drawings, equations), since the focus of these applications has primarily been recognition accuracy rather than document creation.

Handwriting recognition can be implemented in computing devices to input and process various types of graphical objects (also called input elements), hand-drawn or handwritten by a user, such as text content (e.g., alphanumeric characters) or non-text content (e.g. shapes, drawings). Once inputted on a computing device, the input elements are usually displayed as digital ink and undergo handwriting recognition to be converted into typeset versions. The user handwriting input is typically interpreted using a real-time handwriting recognition system or method. To this end, either on-line systems (recognition carried out using a cloud-based solution or the like) or off-line systems may be used.

The user input may be drawings, diagrams or any other content of text, non-text or mixed content of text and non-text. Handwriting input may be made on a structured document according to guiding lines (base lines) which guide and constraint input by the user. Alternatively, a user may handwrite in free-mode, i.e. without any constraints of lines to follow or input size to comply with (e.g. on a blank page).

In handwriting recognition applications, it is usually possible to perform some level of editing on user input displayed on a computing device.

The user may need to edit the text block sections extracted from the handwriting input text, for example in the context of notetaking wherein multiple text blocks may belong together from a contextual point of view.

Conventionally, such applications are however limited in their capabilities to handle editing functions and typically constrain users to adopt behaviours or accept compromises which do not reflect the user's original intent.

As a result, some conventional handwritten recognition applications force users to navigate menus to select and edit ink elements.

The Applicant has found that when using handwriting applications, users generally are unable or do not desire to learn specific gestures that are not natural or intuitive, or to make editing selections through menus and the like.

Typically, the ability in conventional handwriting recognition applications to rearrange text or non-text ink input elements is limited where only certain operations are available, often involving complex or unnatural manipulations by the users. As such, it is generally difficult for users to edit text or non-text context in an ergonomic and efficient manner. These limitations and deficiencies result especially from the fact that the user interface and the associated user manipulations are usually not (or poorly) adapted to the ergonomics, anatomy or physical constraints of the users.

In particular, when various graphical objects are displayed on a screen, it is often physically difficult for a user to select graphical objects, for the purpose of editing for instance. Computing devices running handwriting recognition applications generally does not permit easy and intuitive selection of graphical objects. It is thus fastidious for users to manipulate text and non-text content displayed on a screen.

Improvements are desired to allow easy and intuitive selection of graphical objects (either text and/or non-text) on a computing device.

### SUMMARY OF THE INVENTION

The present invention involves using a computing device to display graphical objects (input elements) in various sections of a display area, and select content contained (partially or totally) in the selection area defined by the user selection gesture for creating new sections of the display. More particularly, this selection area is formed by a selection path defined by the user selection gesture. Further aspects of the present invention will be described hereafter.

According to a first aspect, the invention provides a method implemented by the computing device for merging, on a display, a source block into a target block comprising: displaying, on the display, the source block enclosing a first input text and the target block enclosing a second input text; detecting, on an input interface, a user selection gesture for selecting the source block; detecting, on the input interface, a user dragging gesture for moving the source block over the target block according to an insertion dropping mode; displaying a cursor in the source block; detecting an insertion position in the second input text indicated by the cursor of the source block according to the user dragging gesture; inserting the first input text in the second input text at the insertion position; and resizing the target block to enclose the second input text and the inserted first input text.

According to a particular embodiment, the first input text is recognized from a first group of handwritten input strokes.

According to a particular embodiment, the second input text is recognized from a second group of handwritten input strokes.

According to a particular embodiment, the source block is extracted from a first group of handwritten input strokes, the source block enclosing the first input text and the first input text is recognized.

According to a particular embodiment, the target block is extracted from a second group of handwritten input strokes, the target block enclosing the second input text and the second input text is recognized.

According to a particular embodiment, the first and second input text enclosed in the target block is re-recognized after said inserting.

According to a particular embodiment, the first input text or the second input text is converted as typeset.

According to a particular embodiment, the inserting of the first input text in the second input text generates a merged input text displayed as a mixture of handwritten and typeset text.

According to a particular embodiment, wherein the method comprises switching to the insertion dropping mode in response to the user dragging gesture, wherein said switching includes redisplaying the source text block according to a predefined visual representation.

According to a particular embodiment, the predefined visual representation comprises a predefined size of the source block.

According to a particular embodiment, the user selection gesture for selecting the source block is detected in response to detecting a selection area which is defined as enclosing at least one input element of an initial text block; whereby: the first input text comprises the enclosed at least one input element; and the source block comprises a portion of the initial text block, said portion comprising the enclosed at least one input element.

According to a particular embodiment, the source block and the target block are obtained (or generated) by performing text block extraction from the first group and the second of handwritten input strokes respectively, said block extraction comprising identifying text and non-text strokes and grouping the text strokes into the source block and the target block according to different hypotheses.

According to a second aspect, the invention provides a computer readable program code (or computer program) including instructions for executing the steps of the method of the first aspect of the invention. This computer program may be stored on a recording medium and executable by a computing device, and more generally by a processor, this computer program comprising instructions adapted for the implementation of the method of the first aspect.

The computer program of the invention can be expressed in any programming language, and can be in the form of source code, object code, or any intermediary code between source code and object code, such that in a partially-compiled form, for instance, or in any other appropriate form.

According to a third aspect, the invention provides a non-transitory computer readable medium having a computer program of the second aspect recorded therein. This non-transitory computer readable medium can be any entity or device capable of storing the computer program. For example, the recording medium can comprise a storing means, such as a ROM memory (a CD-ROM or a ROM implemented in a microelectronic circuit), or a magnetic storing means such as a floppy disk or a hard disk for instance.

The non-transitory computer readable medium of the invention can correspond to a transmittable medium, such as an electrical or an optical signal, which can be conveyed via an electric or an optic cable, or by radio or any other appropriate means. The computer program according to the disclosure can in particular be downloaded from the Internet or a network of the like.

Alternatively, the non-transitory computer readable medium can correspond to an integrated circuit in which a computer program is loaded, the circuit being adapted to execute or to be used in the execution of the methods of the invention.

According to fourth aspect, the present invention relates to a computing device for merging a source block into a target block comprising: a display area configured to display the source block enclosing a first input text and the target block enclosing a second input text; an input area configured to detect: a user selection gesture for selecting the source block; and a user dragging gesture for moving the source block over the target block; a block selection module configured to select the source block; a block moving module configured to move the source block; a mode switching module configured to display a cursor in the source block according to an insertion dropping mode; an insertion detection module configured to detect an insertion position in the second input text indicated by the cursor of the source block according to the user dragging gesture; a block resizing module configured to resize the target block to enclose the second input text and the inserted first input text.

The various embodiments defined above in connection with the method of the first aspect apply in an analogous manner to the computing device, the computer program and the non-transitory computer readable medium of the present invention.

For each step (or operation) of the method of the first aspect of the present invention, the computing device of the fourth aspect may comprise a corresponding module configured to perform said step (or operation).

Where functional modules are referred to in the present disclosure for carrying out various steps of the described method(s), it will be understood that these modules may be implemented in hardware, in software, or a combination of the two. When implemented in hardware, the modules may be implemented as one or more hardware modules, such as one or more application specific integrated circuits. When implemented in software, the modules may be implemented as one or more computer programs that are executed on one or more processors.

### BRIEF DESCRIPTION OF THE DRAWINGS

The present system and method will be more fully understood from the following detailed description of the examples thereof, taken together with the drawings. In the drawings like reference numerals depict like elements. In the drawings:

FIG. 1 shows a block diagram of a computing device in accordance with an embodiment of the present invention;

FIG. 2A shows three text blocks enclosing input text examples according to an embodiment of the present invention;

FIG. 2B shows text block example including a moving gesture of a source text block according to an embodiment of the present invention;

FIG. 2C shows the source text block overlapping a target text block according to an embodiment of the present invention;

FIG. 2D shows the source text block overlapping the target text block at an insertion position according to an embodiment of the present invention;

FIG. 2E shows the resulting merged text block enclosing merged input texts at the insertion position according to an embodiment of the present invention;

FIG. 3A shows three text blocks enclosing input text examples including a moving gesture according to an embodiment of the present invention;

FIG. 3B shows the source text block overlapping a target text block according to an embodiment of the present invention;

FIG. 3C shows the source text block, in an insertion dropping mode, overlapping the target text block including a moving gesture of the source text block according to an embodiment of the present invention;

FIG. 3D shows the source text block, in the insertion dropping mode, overlapping another target text block including a moving gesture of the source text block according to an embodiment of the present invention;

FIG. 3E shows the source text block, in the insertion dropping mode, overlapping another target text block including a cursor at an insertion position according to an embodiment of the present invention;

FIG. 3F shows resulting text blocks including a merged text block and an inserted input text according to an embodiment of the present invention;

FIG. 4 shows a flow diagram of an example of the present method for merging a source text block within a target text block according to the present invention.

### DETAILED DESCRIPTION OF EXAMPLE EMBODIMENTS

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and/or circuitry have been described at a relatively high-level, without detail, in order to avoid unnecessarily obscuring aspects of the present teachings.

Reference to and discussion of directional features such as up, down, above, below, lowest, highest, horizontal, vertical, etc., are made with respect to the Cartesian coordinate system as applied to the input interface on which the input to be recognized is made.

Further, the use of the term ‘text’ in the present disclosure is understood as encompassing all alphanumeric characters, and strings thereof, in any written language and common place non-alphanumeric characters, e.g., symbols, used in written text.

The term “non-text” in the present disclosure is understood as encompassing freeform handwritten or hand-drawn content (e.g. shapes, drawings, etc.) and image data, as well as characters, and string thereof, or symbols which are used in non-text contexts. Non-text content defines graphic or geometric formations in linear or non-linear configurations, including containers, drawings, common shapes (e.g. arrows, blocks, etc.) or the like. In unconstrained canvas for instance, text content may be contained in containers or shapes (a rectangle, ellipse, oval shape etc.).

The systems and methods described herein may utilize recognition of users' natural writing or drawing styles input to a computing device via an input interface, such as a touch sensitive screen, connected to, or of, the computing device or via an input device, such as a digital pen or mouse, connected to the computing device. Whilst the various examples are described with respect to recognition of handwriting input using so-called online recognition techniques, it is understood that application is possible to other forms of input for recognition, such as offline recognition in which images rather than digital ink are recognized.

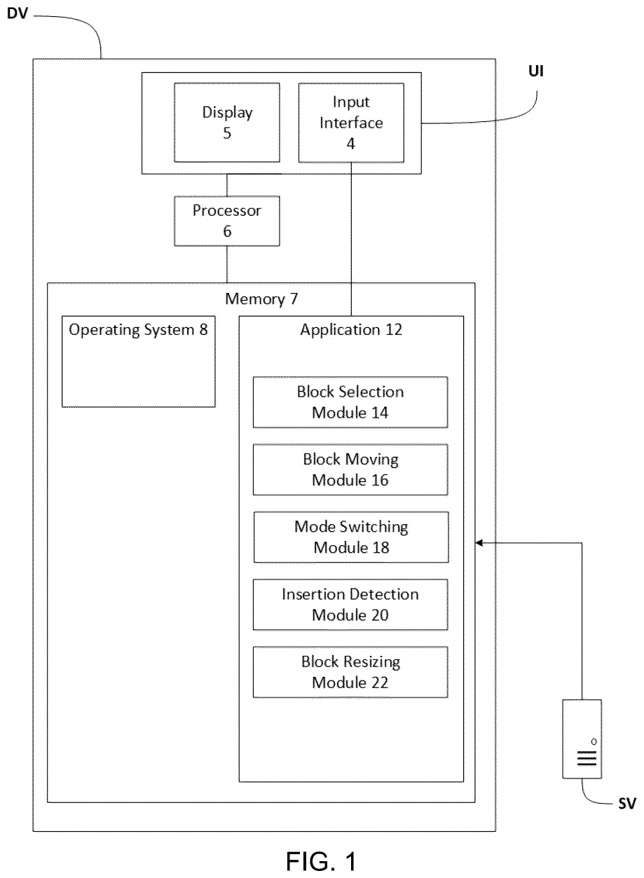

FIG. 1 illustrates a block diagram of a system, comprising a computing device DV, for merging, on a display, a source text block into a target text block.

The computing device DV may be a computer desktop, laptop computer, tablet computer, hybrid computers (2-in-1 s), e-book reader, mobile phone, smartphone, wearable computer, digital watch, interactive whiteboard, global positioning system (GPS) unit, enterprise digital assistant (EDA), personal digital assistant (PDA), game console, or the like. The computing device DV includes components of at least one processing element, some form of memory and input and/or output (I/O) devices. The components communicate with each other through inputs and outputs, such as connectors, lines, buses, cables, buffers, electromagnetic links, networks, modems, transducers, IR ports, antennas, or others known to those of ordinary skill in the art.

In the illustrated example, the computing device DV comprises at least one display 5 for outputting data from the computing device such as images, text, and video. The display 5 may use LCD, plasma, LED, OLED, CRT, or any other appropriate technology that is or is not touch sensitive as known to those of ordinary skill in the art. At least some part of the display 5 may be co-located with at least one input area (or input surface, or input interface) 4. The input area 4 may employ technology such as resistive, surface acoustic wave, capacitive, infrared grid, infrared acrylic projection, optical imaging, dispersive signal technology, acoustic pulse recognition, or any other appropriate technology as known to those of ordinary skill in the art to receive user input in the form of a touch- or proximity-sensitive surface. The input area 4 may be a non-touch sensitive surface which is monitored by a position detection system. The input area 4 may be bounded by a permanent or video-generated border that clearly identifies its boundaries. Instead of, or additional to, an on-board display, the computing device DV may have a projected display capability.

The computing device DV also includes a processor 6, which is a hardware device for executing software, particularly software stored in memory 7. The processor can be any custom made or commercially available general purpose processor, a central processing unit (CPU), commercially available microprocessors including a semiconductor based microprocessor (in the form of a microchip or chipset), microcontroller, digital signal processor (DSP), application specific integrated circuit (ASIC), field programmable gate array (FPGA) or other programmable logic device, discrete gate or transistor logic, discrete hardware components, state machine, or any combination thereof designed for executing software instructions known to those of ordinary skill in the art.

The memory 7 can include any one or a combination of volatile memory elements (e.g., random access memory (RAM, such as DRAM, SRAM, or SDRAM)) and nonvolatile memory elements (e.g., ROM, EPROM, flash PROM, EEPROM, hard drive, magnetic or optical tape, memory registers, CD-ROM, WORM, DVD, redundant array of inexpensive disks (RAID), another direct access storage device (DASD), or any other magnetic, resistive or phase-change nonvolatile memory). Moreover, the memory 7 may incorporate electronic, magnetic, optical, and/or other types of storage media. The memory 7 can have a distributed architecture where various components are situated remote from one another but can also be accessed by the processor 6. Further, the memory 7 may be remote from the device, such as at a server or cloud-based system, which is remotely accessible by the computing device DV.

The memory 7 is coupled to the processor 6, thereby enabling the processor 6 to read information from, and write information to, the memory 7. In the alternative, the memory 7 may be integral to the processor 6. In another example, the processor 6 and the memory 7 may both reside in a single ASIC or other integrated circuit.

The software in the memory 7 includes an operating system 8 and an application 12 in the form of a non-transitory computer readable medium having a computer readable program code (or computer program) embodied therein. The operating system 8 controls the execution of the application 12. The operating system 8 may be any proprietary operating system or a commercially or freely available operating system, such as WEBOS, WINDOWS®, MAC and IPHONE OS®, LINUX, and ANDROID. It is understood that other operating systems may also be utilized. Alternatively, the application 12 of the present system and method may be provided without use of an operating system.

The application 12 includes one or more processing elements related to detection, management and treatment of user input (discussed in detail later). In particular, the application 12 may comprise instructions for executing a method of the invention, as described further below in particular embodiments.

The software may also include one or more other applications related to handwriting recognition (HWR), different functions, or both. Some examples of other applications include a text editor, telephone dialer, contacts directory, instant messaging facility, computer-aided design (CAD) program, email program, word processing program, web browser, and camera.

The application 12, with support and compliance capabilities, may be a source program, executable program (object code), script, application, or any other entity having a set of instructions to be performed. When a source program, the program needs to be translated via a compiler, assembler, interpreter, or the like, which may or may not be included within the memory, so as to operate properly in connection with the operating system. Furthermore, the HWR system with support and compliance capabilities can be written as (a) an object oriented programming language, which has classes of data and methods; (b) a procedure programming language, which has routines, subroutines, and/or functions, for example but not limited to C, C++, Pascal, Basic, Fortran, Cobol, Perl, Java, Objective C, Swift, and Ada; or (c) functional programing languages for example but no limited to Hope, Rex, Common Lisp, Scheme, Clojure, Racket, Erlang, OCaml, Haskell, Prolog, and F #.

Handwriting input entered on or via the input area 4 may be processed by the processor 6 as digital ink. A user may enter a handwriting input with a finger or some instrument such as a pen or stylus suitable for use with the input interface. The user may also enter a handwriting input by making a gesture above the input interface 4 if technology that senses or images motion in the vicinity of the input interface 4 is being used, or with a peripheral device of the computing device DV, such as a mouse or joystick, or with a projected interface, e.g., image processing of a passive plane surface to determine the stroke and gesture signals.

In a particular example, the system and method of the present invention allow handwriting to be input virtually anywhere on the input area 4 of the computing device DV and this input may be rendered as digital ink in the input position on the display area 5. The input area 4 may be provided as an unconstrained canvas that allows users to create object blocks (blocks of text, drawings, etc.) anywhere without worrying about sizing or alignment. However, an alignment structure in the form of a line pattern background may be provided for guidance of user input and the alignment of digital and typeset ink objects. In any case, as users may input handwriting that is not closely aligned to the line pattern or may desire to ignore the line pattern and write in an unconstrained manner, such as diagonally or haphazardly, the HWR system is able to recognize this freely positioned handwriting. This ‘free’ input may be rendered as digital ink at the input position.

Various types of graphical objects can be processed by the computing device, referred to in the present disclosure as the input elements, such as text content (e.g., alphanumeric characters) or non-text content (e.g. shapes, drawings).

On the computing device, the input elements can be typeset from a keyboard, hand-drawn or handwritten from a pen or a finger by a user. The input elements can be displayed as digital ink or typeset version.

A handwriting input is formed of (or comprises) one or plural strokes. Each stroke is characterized by at least a stroke initiation location, a stroke termination location, and a path connecting the stroke initiation and termination locations. Further information such as timing, pressure, angle at a number of sample points along the path may also be captured to provide deeper detail of the strokes.

More specifically, the computing device DV may be configured to group strokes of digital ink into blocks (or block sections) of one or more strokes, each block being either a text block or non-text block. Each stroke contained in a text block may be a part of a text symbol.

This grouping allows generating or combining the strokes into coherent single blocks, as text blocks or non-text blocks. Different strategies may be implemented to aggregate classification results for each stroke. The generation of blocks may also be based on other predefined constraints such as stroke level constraints, spatial constraints, etc. to make it more comprehensible, robust and useful for subsequent recognition. In a particular example, these constraints may comprise any one (or all) of the following: overlapping strokes are grouped into a single block; the strokes are grouped into horizontally spaced blocks; a threshold is set for minimum and/or maximum strokes per block (to remove noise), etc.

In a particular example, the computing device DV is configured to perform the handwriting recognition including a text block extraction to extract text blocks from strokes of digital ink of the handwritten input text.

In a particular example, accurately detecting and identifying the type of content is a first step in a recognition of the text content. Disambiguating between text and non-text content is one step whereas another step is the accurate extraction of text blocks.

In a particular example, the computing device DV may be configured to apply, to strokes of digital ink, a two-step process to identify and output text blocks. As a first step of this two-step process, a text versus non-text classification may be performed to attribute a label to each stroke indicating if it's a textual stroke or a non-textual stroke. Text strokes aims to be recognized and transcribed at some point. The non-textual strokes are actually any other strokes that do not correspond to text. The non-textual strokes can be any type of strokes, such as drawings, table structures, recognizable shapes, etc.

Once the text strokes have been identified, then, in a second step of this two-step process, the text strokes are gathered (grouped) into text blocks. A text block is the input entity of the text recognition process performed by a text recognizer. A page can contain several text blocks without any prior assumption on their layout in the page.

The text block extraction (TBE) process may receive as input a set of text strokes and a set of non-text strokes in a same page of content and outputs a set of text block tags (one for each text block detected in the page).

Particular exemplary embodiments of this TBE are now described hereafter for illustrative purpose only.

The TBE is a sequential gathering process and can be considered as a bottom-up approach: it starts from the smallest entities (the strokes) and gathers (groups) them until having the biggest entities (the text blocks).

In a particular example, the TBE sequence comprises the following:
i) temporally gathering strokes into word hypotheses;
ii) temporally gathering words into text line hypotheses;
iii) spatially gathering text lines to create text block hypotheses;
iv) inside text blocks, merging spatially some text line hypotheses; and
v) iterating steps 3 and 4 until the number of text line is steady.

More specifically, the step of temporally gathering strokes into word hypotheses may use a dynamic programming algorithm to temporally combine strokes into hypotheses and select at the end the best set of word hypothesis in the input stroke sequence i.e. the set of words that minimizes a cost. The aim of the dynamic programming algorithm is to test all possible hypothesis creation in the input stroke sequence. It means that the strokes need to be ordered to have a sequence as the input. The natural order is to use the temporal one: the order of creation of the strokes.

To evaluate each hypothesis, a cost function may be defined that has a low value for the good word hypotheses and high values for bad ones. One such cost function that may be used for this step only relies on the standard deviation of Y coordinates of stroke points relative to a global text scale estimated on the set of text strokes in the page.

Some rules may also be used to discard certain hypotheses. One such rule is based on the X (horizontal) distance and the Y (vertical) distances between strokes in a hypothesis that must be under a predefined horizontal or vertical threshold, respectively (the vertical and horizontal thresholds are factors of the global text scale).

Another factor to create the word hypotheses may be the presence of non-textual strokes. The non-textual strokes may cut (or stop) a word hypothesis creation. For example, in a freeform handwriting mode, if a non-text stroke is detected between two text strokes, then any corresponding word hypotheses are discarded.

At the end of this step, a sequence of words may be temporally ordered. To temporally gather words into text line hypotheses a dynamic programming algorithm may also be used to combine words from the word sequence into text lines hypotheses. This allows to create the biggest text lines containing words written in a perfect temporal order.

In one example, the cost function defining what is a good temporal text line hypothesis may involve one or any combination of the following four sub costs:
i) a standard deviation of point Y coordinates around an estimated height of text with the aim to maintain the deviation close to zero while gathering strokes that are horizontally aligned (for the Y coordinates that are span globally in the same range) and that grows quickly in case of line breaks;
ii) an extrema overflow cost that corresponds to the way strokes in a word hypothesis share a close height, penalizing a hypothesis that contains too big outliers;
iii) a horizontal gap cost between strokes inside a hypothesis where the cost increases with the size of the maximum horizontal gap in the hypothesis; and
iv) a size cost around a global text scale avoiding too small hypotheses.

Presence of non-textual strokes can also discard some hypotheses. If a non-text stroke is found in between two words, then those two words can't be considered as belonging in the same text line hypothesis. At the end of this step, a set of text lines with a coherent writing order is produced.

A post processing may take place at this stage to try to merge obvious temporal hypotheses and have better text line hypotheses for the next step. After a spatial ordering of the text line hypotheses, hypotheses that are well aligned horizontally may be merged, assuming that there is no non-text stroke in between them and that they are not too far horizontally relative to each other.

To spatially gather text lines to create text block hypotheses again a dynamic programming approach may be used to gather line hypothesis in the most coherent text block set regarding a cost function. But this time the temporal order is ignored and instead the text line hypothesis are ordered vertically. The value used to order the text line is the vertical position of the baseline. Iteratively, the algorithm will try to add a new text line in several sets of text blocks. For computation efficiency, not all possible text block sets are kept but only the ones that have the lower cost, e.g. the ten best ones. While trying to add a new text line, the algorithm attempts to add it in each text block hypothesis of each text block set available and also attempts to add this new text line as a new single line text block in each set.

In a particular example, the computing device DV is configured to detect and display the handwritten input text which is input using the input interface 4, for instance in a free handwriting format (or free handwriting mode) which affords complete freedom to the user during handwriting input, this being sometimes desirable for instance to take quick and miscellaneous notes or make mixed input of text and non-text. In the following examples, it is assumed for illustrative purpose only that the text handwriting is input in the free handwriting mode (or format) as described above.

The display 5 of the computing device DV is configured to display, in a display area (or input area), text handwriting formed by a plurality of strokes (or input strokes) of digital ink. In the examples described hereafter, it is assumed for illustrative purpose only that the detected strokes are input along (or substantially along) a same handwriting orientation X (e.g. the horizontal orientation in the present case). Variations of handwriting orientations, e.g. deviations from an intended orientation within the same line, may however be possible in some cases. Text handwriting may of course take many different forms and styles, depending on each case.

In a particular example, the computing device DV is configured to display strokes within (or as part of) boxes, these boxes being representative of the respective block(s) to which each stroke belongs.

The present system and method may further allow users to interact with the digital ink itself and provide meaningful guidance and results of that interaction. Interaction is assisted by the performance of segmentation of strokes in the recognition process and using information on this segmentation to allow management of an input or editing cursor that acts as a pointer for character level interactions and editing operations.

As previously indicated, the software in memory 7 (FIG. 1) may comprise one or more applications or functions related to HWR. Exemplary implementations of a HWR system are described hereafter for illustrative purpose only.

In a particular example, the HWR system includes stages (and corresponding modules) such as preprocessing, recognition and output. The preprocessing stage may process the digital ink to achieve greater accuracy and reducing processing time during the recognition stage. This preprocessing may include normalizing of the path connecting the stroke initiation and termination locations by applying size normalization and/or methods such as β-spline approximation to smooth the input. The preprocessed strokes may then be passed to the recognition stage which processes the strokes to recognize the objects formed thereby. The recognized objects may then be output to the display 5 as a digital ink or typeset ink versions of the handwritten input.

The recognition stage may include different processing elements or experts. Three expert systems, a segmentation expert system, a recognition expert system, and a language expert system, collaborate through dynamic programming to generate the output. An expert system is a computer system emulating the decision-making ability of a human expert. Expert systems are designed to solve complex problems by reasoning through bodies of knowledge, represented mainly as if-then rules rather than through conventional procedural programming.

Some aspects of these experts are described here below for illustrative purpose only to facilitate understanding of the present invention. However, no further detail is provided to avoid unnecessarily obscuring the present disclosure. Details of implementing handwriting recognition can for instance be found in EP patent application N° 1 836 651 A1.

The segmentation expert defines the different ways to segment the input strokes into individual element hypotheses, e.g., alphanumeric characters and mathematical operators, text characters, individual shapes, or sub expression, in order to form expressions, e.g., words, mathematical equations, or groups of shapes.

For example, the segmentation expert may form the element hypotheses by grouping consecutive strokes of the original input to obtain a segmentation graph where each node corresponds to at least one element hypothesis and where adjacency constraints between elements are handled by the node connections.

Alternatively, the segmentation expert may employ separate experts for different text or non-text input, such as characters, drawings, equations, and music notation.

To this end, the segmentation expert may process the plurality of ink points into a plurality of segments each corresponding to a respective sub-stroke of the stroke represented by the original input. Each sub-stroke comprises a respective subset of the plurality of ink points representing the stroke.

The insight behind sub-stroke segmentation is to obtain a sequential representation that follows the path of the stroke. Each segment corresponds as such to a local description of the stroke. Compared to representing the stroke as a mere sequence of points, sub-stroke segmentation permits to maintain path information (i.e., the relationships between points within each segment) which results in a reduction in computation time.

Different sub-stroke segmentation techniques may be used according to embodiments. In an embodiment, sub-stroke segmentation based on temporal information is used, resulting in the plurality of segments having equal duration. In an embodiment, the same segment duration is used for all strokes. Further, the segment duration may be device independent.

The recognition expert associates a list of word candidates with probabilities or recognition scores for each node of the segmentation graph. These probabilities or recognition scores are based on language information. The language information defines all the different characters and words of the specified language.

The language expert generates linguistic meaning for the different paths in the segmentation graph using language models (e.g., grammar or semantics). The expert checks the candidates suggested by the other experts according to linguistic information. The linguistic information can include a lexicon, regular expressions, etc. and is the storage for all static data used by the language expert to execute a language model. A language model can rely on statistical information on a given language.

According to a particular embodiment, when running the applications 12 stored in the memory 7 (FIG. 1), the processor 6 is configured to implement modules, namely: a block selection module 14, a block moving module 16, a mode switching module (or displaying module) 18, an insertion detection module 20 and a block resizing module 22.

The block selection module 16 is configured to detect, with (or on) the input interface, a user selection gesture (also name selection gesture) for selecting a source text block (also named source block) enclosing a first input text.

The user selection gesture is performed on the computing device DV to select the source text block. The block selection module 16 is thus configured to select said text block based on a selection defined by the user through the user selection gesture.

In a particular embodiment, the selection gesture is (or comprises) a tap gesture detected on the input surface for selecting the source text block.

In a particular embodiment, the selection gesture is (or comprises) a slide gesture (or free-selection gesture, or “lasso” gesture) on the input surface 4. This selection gesture may form a closed (or nearly closed) loop (or path), such as a roughly circular or oval form or the like, or at least a geometric shape which allows the computing device to deduce therefrom a selection area which contains at least the source text block.

In a particular embodiment, the selection area defined by the slide gesture may contain one or more selected input elements consisting in (or comprising) the first input text.

The first input text may be (or correspond to) a block portion which is split from an initial text block and considered as a floating object including information about a selected input element being pick up the initial block section while the slide gesture is in progress, as further detailed in another patent application. The source text block enclosing the first input text may therefore be created at release of the slide gesture, when the user ends his/her interaction with the input surface (i.e. a pen up event), as further detailed below.

In a particular embodiment, in response to the detection of this selection gesture, the display 5 is configured to display a visual indication of a box representative of the selected source text block, thereby rendering the user with visual feedback of the selection. The box representative of the block may be defined as a bounding box of the enclosed input text.

The block moving module 16 is configured to detect, on the input interface 4, a user moving gesture for moving the selected source text block over a target block (also named target text block or targeted block) comprising (or enclosing) a second input text. Moving the source text block over (or on top of) the target block may mean for instance that the bounding box of the source text block overlaps a bounding box of the target block. Such an overlapping may result from having all or only part of the source text block positioned over the target block on the display.

The user moving gesture defines a drag movement applied to the selected source text block. In a particular example, the block moving module 16 continuously monitors the current position of the selected source text block while it is being dragged according to the user moving gesture. By monitoring the current position of the of the selected source text block, the computing device DV can accurately detect when and how the source text block is moved over the target block.

To indicate the end of the moving gesture, the user may release for instance the input surface 4 (finger up). The block moving module 16 may be configured to detect that the drag movement is terminated in response to this release and thus to drop the selected source text block at the current location according to a dropping mode.

The selected block may be dropped according to a certain dropping mode, wherein the dropping mode may be a regular-mode (i.e. a regular dropping mode) or an insertion-mode (i.e. an insertion dropping mode), determined by a certain time-lapse and a drop position and indicated by a visual feedback, as further detailed below.

In a particular example, when the bounding box of the selected block is moved over an empty space of an underlying canvas (i.e. an area without the target block), the selected block is released according to the regular mode, leading to a simple translation of the block.

In a particular example, when the bounding box of the selected block overlaps at least partially the bounding box of the targeted block for at least the certain time-lapse, the selected block is released according to the insertion mode, leading to an insertion of the first text element into the second text element, as further detailed below.

In a particular example, the block moving module 18 is configured to detect the overlap of the selected block over the targeted block for the certain time-lapse and then adapts the visual feedback on the display to indicate that the dropping mode is insertion mode (i.e. to indicate that the computing device DV operates according to the insertion dropping mode). The block moving module 18 may display the visual feedback (i.e. a caret, a rectangle, a circle or the like) to visually indicate the dropping mode. Additionally, the visual display of the supplying block may change during the insertion dropping mode, for example the opacity, and/or the size of the selected block.

Additionally, while the user moving gesture is still being performed, the block moving module 18 displays an insertion cursor (also named cursor) moving along with the first input text of the selected text block to select an insertion position within the second input text.

As long as the user moving gesture is in progress, another existing text block may be chosen as the target text block by dragging the source text block over existing text blocks of the display. Additionally, the insertion position may vary within the second input text of the chosen target text block.

At release of the moving gesture, when the user ends his/her interaction with the input surface 4 (i.e. a pen up event), the fist input text enclosed in the source text block may be inserted at an insertion position as further described below.

More specifically, the insertion detection module 20 is configured to detect an insertion position in the second input text of the target block, this insertion position being marked by the insertion cursor according to the moving gesture. To this end, the insertion cursor may be moved by the computing device DV along with the source text block according to the user moving gesture. The insertion cursor marks an insertion position.

The insertion detection module 20 is further configured to insert the first input text at the insertion position within the second text to generate a merged input text.

The block resizing module 20 is configured to resize the target text block to enclose the first text input along with the inserted second text input. In other words, the block resizing module 20 resizes the target text block to accommodate the merged input text within said target text block. In response to the insertion of the first input, the size of the target text block may thus be adjusted to the merged input text by increasing said current block in a first resizing orientation. The resizing may also lead to text reflow of the merged input text in target text block, although embodiments without text reflow are also possibles.

The source text block may be deleted in response to the insertion of the first input text within the second input text in the target text block.

The present system and method advantageously allow to manually correct an existing block that does not match the intention of the user, either because the text input elements are not recognized as expected or because block creation by other existing method leads to mistaken selection of the input text elements. The present system and method allows to aggregate, quickly and efficiently, content belonging to a same text with simple and intuitive gestures and improve handwritten recognition outcome by transforming the linguistic context of the rearranged text blocks. Modification of the linguistic context of recognition may lead to different probabilistic scores of the word candidates and better handwritten recognition accuracy, as further exemplify below.

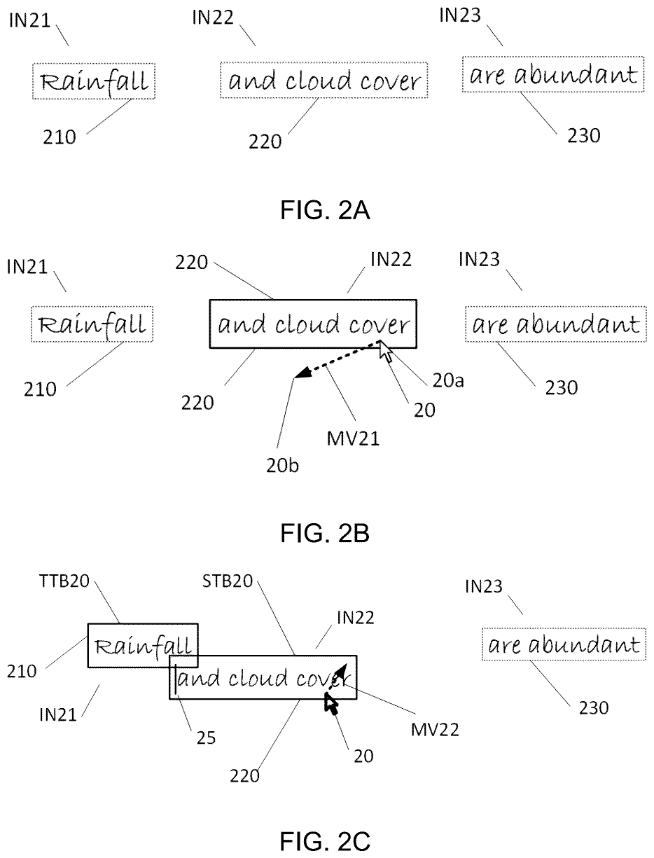

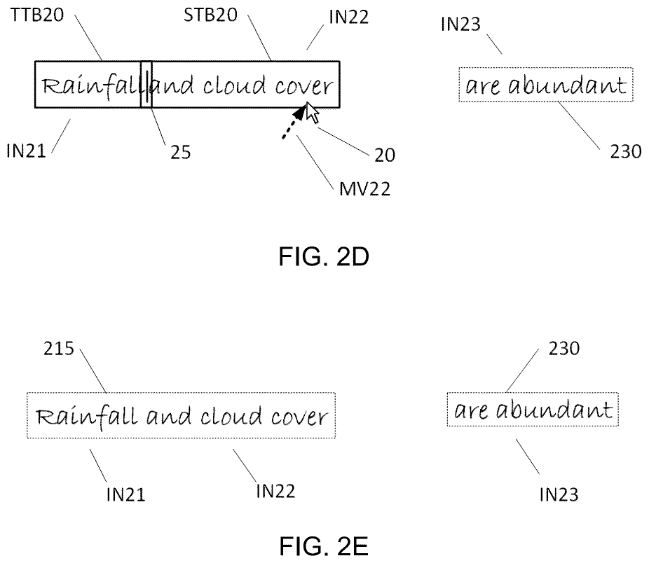

FIGS. 2A, 2B, 2C, 2D and 2E show an example of a method for merging a source block (also named source block section) into a target block (also named target block section) according to a particular embodiment of the invention. This merging method may be performed the computing device DV as previously described according to a particular embodiment of the invention, for instance by executing instructions of the application 12.

FIG. 2A shows, on the display 5, three text blocks 210, 220 and 230 extracted from three groups of handwritten input text IN21, IN22, IN23 by the HWR system implemented by the computing device DV. The three input text elements are handwritten in this example without any constraint of lines, size, orientation or the like to comply with, thereby allowing the user to handwrite text content in a free and easy manner. The computing device DV displays the plurality of input strokes of the handwriting input on the display 5 in accordance with the free handwriting format.

The first text block 210 encloses (or comprises) the first input text IN21 displayed as “Rainfall”. The second text block 220 encloses (or comprises) the second input text IN22 displayed as “and cloud cover” and the third text block 230 encloses (or comprises) the third input text IN23 displayed as “are abundant”. These input texts are provided solely for illustrative purpose.

It is assumed that the computing device DV extracts three different text blocks 210, 220 and 230 from the handwriting input text, although the three input text IN21, IN22 and IN23 semantically belong in this case to a same sentence. The system and method of the present invention allow the user to merge the text blocks as described below in a particular embodiment.

FIG. 2B shows the three input-texts IN21, IN22 and IN23 and a first pointer 20 displayed over the second input text IN22. The computing device DV detects a user selection gesture and selects the second text block 220, as a source block, based on this user selection gesture.

In response to the detection of this selection gesture, the bounding box of the second text block 220 may be displayed according to a predefined visual representation, for instance with accentuated borders as a visual indication of the selected block on the display.

Additionally, as also shown in FIG. 2B, the computing device DV detects a first user moving gesture MV21 (or dragging gesture) for moving the selected text block 220 as illustrated by a first dash arrow. The moving gesture MV21 is initiated at an initial position 20a of the pointer 20 and ends at a final point 20b of the pointer 20. The selected text block 220 may be moved and dropped anywhere over the canvas according to: a regular mode when a drop position is defined at an empty space of the canvas, or an insertion dropping mode when the drop position is defined over an existing block, as illustrated below.

FIG. 2C shows the three input-texts IN21, IN22, IN23 and the first pointer 20 at the first final point. The second text block 220 including the second input text IN22 is moved according to the first moving gesture MV21. This movement induced by the first moving gesture MV21 causes the second text block 220 to overlap the first text block 210 including the first input text IN21. The overlapping of second text block 220 over the first text block 210 may cause a bounding box of the first text block 210 to be displayed on the display area 5 to provide visual feedback to the user.

The overlap of the second text block 220 over the first text block 210 triggers a switch to the insertion dropping mode (also named insertion mode), such that the second text block 220 may be dropped, as a source text block STB20, into (or over) the first text block 210, as a target text block TTB20. In other words, in response to the detection of the above-mentioned overlap, the computing device DV operates into the insertion mode, thereby allowing insertion of the second input text IN22 into the first input text IN21.

As shown in FIG. 2C, the switch to the insertion mode of the second text block causes a cursor 25 to be displayed at a first position of the second input text IN22 within the source text block STB20.

Additionally on FIG. 2C, the computing device DV may detect a second user moving gesture MV22 for moving the source text block STB20 illustrated by a second dash arrow. The second moving gesture MV22 is initiated at a second initiation point of the pointer 20 and ends at a second final point of the pointer 20. The second input text IN22 and the displayed cursor 25 are moved together according to the second moving gesture MV22 of the source text block. The second final point is located within the targeted block TTB20, such that the source text block STB20 remains in the insertion dropping mode. The displayed cursor 25 is moved or positioned over the first input text IN21 according to the second moving gesture MV22 to define an insertion position within the first input text IN21.

FIG. 2D shows the three input-texts IN21, IN22 and IN23, the target text block TTB20 enclosing the first input text IN21 and the source text block STB20 enclosing the second input text IN22. At this stage, the first pointer 20 is located at the second final point of the second moving gesture MV22 for moving the source text block STB20 over the target text block TTB20. The source text block STB20 includes the cursor 25. The cursor 25 is positioned over the last position (i.e. at the end) of the first input text IN21 of the target text block TTB20 in response to the second moving gesture MV22. The last position of the first input text constitutes in this example an insertion point of the second input text into the first input text.

FIG. 2E shows the three input-texts IN21, IN22 and IN23 and a resized text block 215 enclosing (or comprising) the first input text IN21 and the second input text IN22 added into the first input text IN21. In response to the second moving gesture MV22 shown in FIG. 2D, the source text block STB20 is released (or dropped) over the target text block TTB20, this release causing the second input text IN22 to be inserted at the insertion position (i.e. at the end in this example) in the first input text IN21. Additionally, the first text block TTB20 is resized to enclose (or comprise, or accommodate) the first input text IN21 and the second input text IN22 within a resized text block 215. As a result, the second text block 220 is deleted. The insertion of the second input text IN22 in the first input text IN21 causes re-recognition of the merged second and first input text enclosed in the target text block TTB20 (not shown). The re-recognition of the merged input text may modify the outcome of the recognition process. In another example (not shown), the outcome of the recognition of the merged first and second input text enclosed in the target block leads to modified recognition results and different converted text. The converted merged input text may be different from the converted first input IN21 displayed along the converted second input IN22.

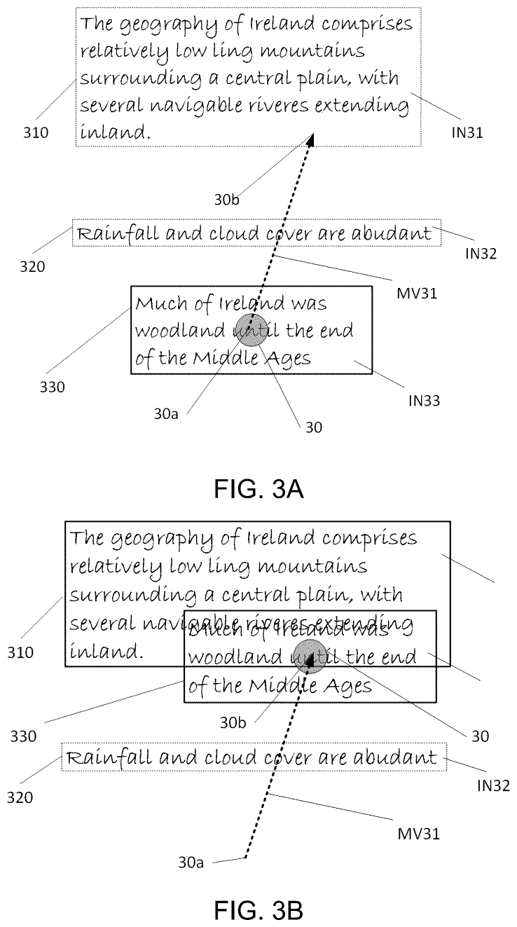

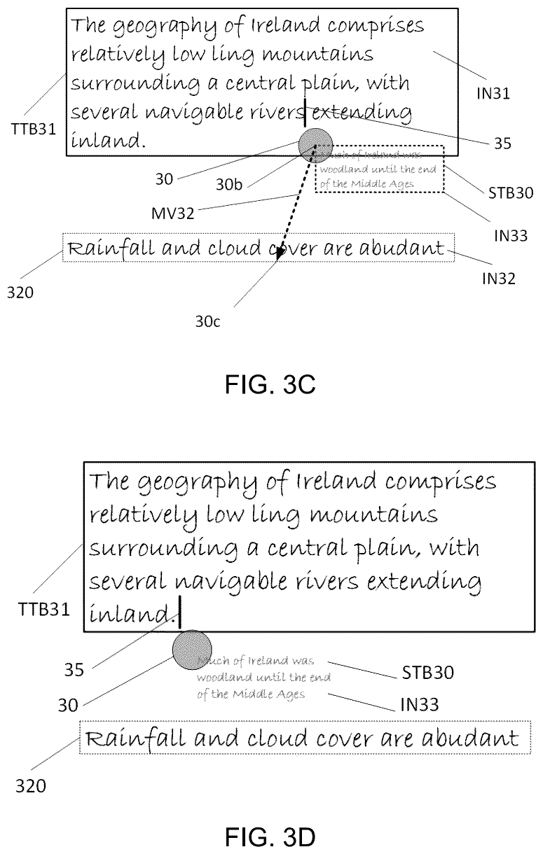

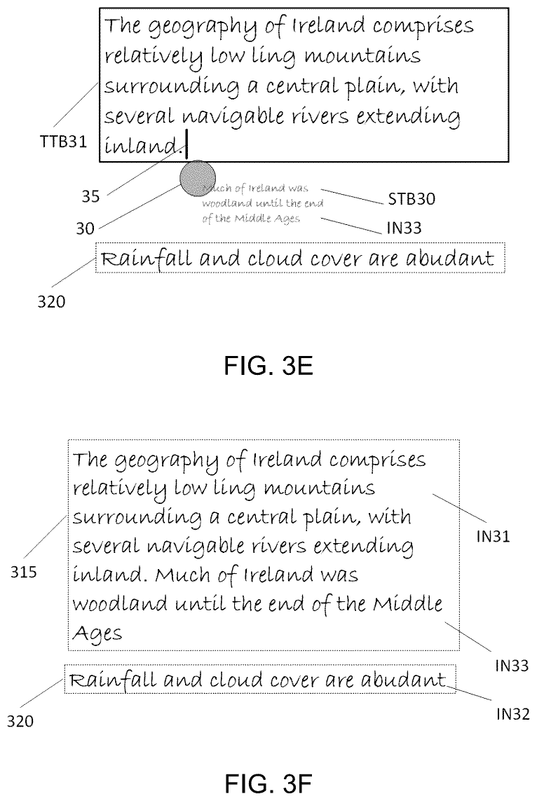

FIGS. 3A, 3B, 3C, 3D and 3E show an example of a method for merging a source block (or source block section) into a target block (or target block section) according to a particular embodiment of the invention. This method may be implemented by the computing device DV as previously described, for instance by executing instructions of the application 12.

FIG. 3A shows, on the display 5, handwritten input text extracted as three text blocks 310, 320 and 330 by the HWR system. The three input text elements may be handwritten without any constraint of lines, size, orientation or the like to comply with, thereby allowing the user to handwrite text content in a free and easy manner. The computing device DV displays the plurality of input strokes of the handwriting input on the display 5 in accordance with the free handwriting format.

The first text block 310 encloses (or comprises) a first input text IN31 displayed as five text lines TL1, TL2, TL3, TL4 and TL5. The second text block 320 encloses (or comprises) a second input text IN32 displayed as one text line TL6. The third text block 330 encloses (or comprises) a third input text IN33 displayed as three text line TL7, TL8 and TL9.

As shown in FIGS. 3A and 3B, the third text block 330 is selected in response to a user selection gesture detected by the computing device DV. In response to this selection, the bounding box of this third text block 330 may be displayed with accentuated borders as a visual indication of the selection of this block on the display. A first pointer 30 displayed over the third input text IN33 is shown as a dark circle.

Additionally, the computing device DV detects a first user moving gesture MV31 (or dragging gesture) for moving the selected text block 330 illustrated by a dash arrow. The moving gesture MV31 is initiated at an initial point 30a of the pointer 30and ends at a final point 30b of the pointer 30. The selected text block 330 may be moved and dropped anywhere over the canvas according to: a regular mode when a drop position is defined at an empty space of the canvas, or an insertion mode (or insertion dropping mode) when the drop position is defined over an existing block. The insertion dropping mode is performed (or triggered) when the selected text block is moved over an underlying text block as further explained below.

FIG. 3C shows the three input texts IN31, IN32, IN33 and the pointer 30 at the final point 30b. The third text block 330 including the third input text IN33 is moved according to the first moving gesture MV31. In response to the first moving gesture MV31, the selecting pointer 30 of the third block section 330 overlaps (or is positioned over) the first text block 310 at the position 30b. The overlapping pointer 30 may cause a bounding box of the first text block 310 to be displayed on the display area 5.

The overlapping pointer 30 triggers a switch of the computing device DV1 to the insertion mode of the third text block 330. In other words, in response to detecting the above-mentioned overlap, the computer device DV operates according to (or switches into, or initiates) the insertion dropping mode. The switch to the insertion mode may occur after a certain time lapse while the overlapping pointer 30 is hold over the target text block 310 for, for example 0.5 seconds over the first text block 310.

The switch to the insertion mode of the third text block 310 may cause the third text block 330 to be redisplayed as a source text block STB30.

A cursor 35 is displayed over the overlapping point 30 and over the source text block STB30, such that the third text block may be dropped, as a source text block STB30, over the first text block, as a target text block TTB30.

According to the insertion dropping mode, the computing device DV displays a cursor 35 at a position defined by the current position of the overlapping pointer 35. In this example, the cursor 35 is thus positioned above the overlapping pointer 30 within the first input text IN31 of the target text block TTB31. As shown, the cursor 35 is thus positioned above (or next to) the third input text IN33, such that the third input text is advantageously not hiding the cursor.

Additionally, the visual representation (or design) of the source text block STB30 may be modified (or switched) in accordance with the insertion dropping mode to advantageously increase visibility of the target text block TT30 and facilitate the positioning of the cursor 35 within the third input text IN31.

The size of the switched source text block STB30 may be reduced, for instance to certain dimension, for example a 30 millimeters wide rectangle. The opacity of the content may be reduced, for example by 50%, a white background of the source text block may be set to white at a certain opacity, for example of 75%, and the borders of the rescaled source text block may disappear. As a result of this change of visual representation, the source text block may be moved or rearranged such that the overlapping pointer 30 is positioned in the top left corner (or any suitable predefined position) of the reduced text block STB30.

Additionally on FIG. 3C, the computing device DV may detect a second user moving gesture MV32 for moving the source text block STB30 illustrated by a second dash arrow. The second moving gesture MV32 is initiated in this example at the initial point 30b of the pointer 30 and ends at a final point 30c of the pointer. The third input text IN33 and the displayed cursor 35 are thus moved together according to the second moving gesture MV32 of the source text block.

The second final point 30c is located within the second text block 320, such that the source text block remains in the insertion dropping mode, as shown on FIG. 3D.

FIG. 3D shows the cursor 35 positioned over the second input text IN32 according to the second moving gesture MV32 to define an insertion position within the second input text IN32. Therefore, the second text block becomes the target text block TTB32 enclosing the second input text. The source text block STB30 enclosing the third input text remains in the insertion dropping mode as it is hold over the second text block for the certain time-lapse, the source text block STB30 is displayed as switched source text block as detailed in FIG. 3C. In the insertion dropping mode triggered by the second moving gesture MV32, the second text block 320 is set as a target text block TTB32.

Additionally on FIG. 3D, the computing device DV may detect a third user moving gesture MV33 for moving the source text block STB30 illustrated by a third dash arrow. The third moving gesture MV33 is initiated at the initial point 30c of the pointer and ends at a final point 30d of the pointer. The third input text IN33 and the displayed cursor 35 are moved together according to the second moving gesture MV33 of the source text block.

The third final point 30d is located within the first text block 310, such that the source text block remains in the insertion dropping mode, as shown on FIG. 3E.

The source text block STB30 includes the cursor 35. The cursor is positioned over the last position of the first input text IN31 of the target text block TTB31 in accordance with the third moving gesture MV33. The last position of the first input text is an insertion point of the third input text in the first input text.

FIG. 3F shows the three input-texts IN31, IN32 and IN33 and a resized text block 315 enclosing the first input text IN31 and the third input text IN33 added to the first input text. In response to the third moving gesture MV33 shown in FIG. 3D, releasing the source text block STB30 over the target text block TTB31 causes the third input text to be inserted at the insertion position into the first input text. Additionally, the first text block 310 is resized to enclose the first input text IN31 and the third input text IN33 within one text block 315. The third text block 330 is deleted.

The insertion of the third input text IN33 in the first input text IN31 causes re-recognition of the merged first and third input text enclosed in the resized text block 315 (not shown). The re-recognition of the merged input text may modify the outcome of the recognition process. In another example (not shown), the outcome of the recognition of the merged first and third input text enclosed in the target block may lead to modified recognition results and different converted text. The converted merged input text may be different from the converted first input IN31 displayed along the converted third input IN33.

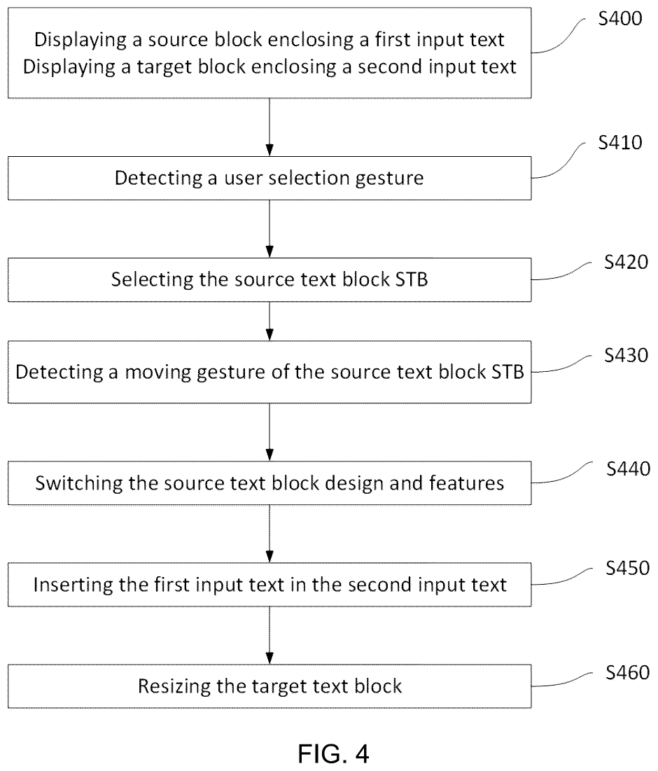

A method implemented by the computing device DV (as described earlier with reference notably to FIG. 1-3) for merging, on the display 5, a source text block into a target text block is now described with reference to FIG.4, in accordance with a particular embodiment of the present invention. More specifically, the computing device DV implements this method by executing the application 12 stored in the memory 7.

In a displaying step S400, the computing device DV displays, on the display 5, a source text block comprising (or enclosing) a first input text and a target text block comprising (or enclosing) a second input text. The text blocks may include input elements hand-drawn or typeset by a user using an appropriate user interface, although other examples are possible. The source and target text blocks may be obtained by any appropriate means by the computing device DV.

The above-mentioned input elements may comprise text handwriting, each of these elements being formed by one or more strokes of digital ink. As mentioned earlier, handwriting recognition may be performed on text input elements. Text elements may be recognized as characters, words or text-lines. In addition, each input element may be converted and displayed as typeset input elements. The handwriting recognition (if any) may be performed by the computing device DV or by any other means.

In a selection gesture detecting step S410, the computing device DV detects a user selection gesture performed with the input surface 4 to select the source block. In other words, the computing device DV detects, with (or on) the input surface 4, a user selection gesture for selecting the source block.

In a particular embodiment, the computing device detects a tap gesture on the input surface as the user selection gesture for selecting the source text block.

In a text block selecting step S420, the computing device DV selects the source text block STB.

In a particular embodiment, the computing device DV detects (S410) initiation of a user selection gesture performed by a user with the input surface 4 to define a selection area. The user selection gesture is an interaction of a user's body part (or any input tool) with the input surface 4 which may cause generation of a stroke of digital ink on the display device along the selection path. Display of this digital ink provides visual feedback to assist the user while he/she is drawing a selection path in the display area. The computing device DV deduces therefrom a selection area which contains at least the source text block. In other words, upon detecting that the source text block is contained (totally or at least partially) within the selection area, the computing device DV selects (S420) the source text block.

In a moving gesture detecting step S430, the computing device DV detects, on the input interface 4, a user moving gesture (or user dragging gesture) for moving the selected source text block over a target block. In response to the user moving gesture, the bounding box of the selected block overlaps a bounding box of the target block.

The user moving gesture defines a drag movement applied to the selected block. The computing device DV may monitor the current position of the selected block as it is being dragged, thereby allowing the current location of the selected block to be checked.

In a particular example, the computing device DV detects that the user releases the input surface 4 (finger up), thereby indicating the end of the moving gesture. The computing device DV may detect termination of the moving gesture, wherein the current location of said moving gesture (or of a pointer used for performing the moving gesture) indicates a final point of moving gesture for dropping the source text block according to an insertion dropping mode.

The selected block is dropped according to a certain dropping mode, wherein the dropping mode may be a regular-mode or an insertion-mode, determined for instance by a certain time-lapse and a drop position and indicated by a visual feedback, as further detailed below.

In a particular example, when the bounding box of the selected block is moved over an empty space of an underlying canvas, the selected block is released according to the regular mode, leading to a simple translation of the block.

In a particular example, when the bounding box of the selected block overlaps at least partially the bounding box of the target block (for instance for at least the certain time-lapse), the selected block is released according to the insertion mode (or insertion dropping mode), leading to an insertion of the first text element into the second text element, as further detailed below. It should be noted that embodiments are possible without applying the condition on the time-lapse.

In a dropping mode switching step S430, the computing device DV detects an overlapping area of the source text block over the target block (for instance for the certain time-lapse). In response to this detection, the computing device DV switches to an insertion dropping mode. In other words, the computing device DV operates according to an insertion dropping mode to allow insertion of the first input text into the second input text.

In a particular embodiment, when the overlapping source block is hold above the target block with a predetermined area threshold (and possibly for the predetermined time-lapse), the computing device DV may switch (or change) a visual representation (design, features, etc.) of the source text block from a regular dropping mode to an insertion dropping mode to provide visual feedback to the user.

In a particular embodiment, a pointer of the moving gesture may be redisplayed as a predefined shape to visually indicate the insertion dropping mode (i.e. a caret, a rectangle, a circle or the like).

When switching to (or operating according to) the insertion dropping mode, the computing device DV may adapt the visual representation (or design) of the source text block, on the display, to visually facilitate the selection of an insertion position within the second input text.

In a particular embodiment, the visual display of the source block may be redisplayed as a predefined design to visually indicate the insertion dropping mode, for example as a predefined size of the selected source block and/or, a predefined opacity of the background of the selected source block. The definition of the design of the selected source block, in the insertion dropping mode, may be set in a way to facilitate selection of the insertion position of the first input text within the second input text.

Additionally, while the user moving gesture is still being performed, the computing device DV displays an insertion cursor moved along with the first input text of the selected text block in accordance with the user moving gesture.

As long as the user moving gesture is in progress, the insertion position of the selected source text block may be changed. Any existing text block may be chosen as the target text block by dragging the source text block over existing text blocks of the display, and, any insertion position within the input text of the chosen target text block may be chosen based on the position of the insertion cursor relative to the second input text of the target block.

In an input text insertion step S450, the computing device DV detects an insertion position in the first input text marked by the insertion cursor of the source block according to the user moving gesture. To this end, the insertion cursor is moved along with the source text block according to the user moving gesture. The insertion cursor marks the insertion position within the second input text. At release of the moving gesture, when the user ends his/her interaction with the input surface (i.e. a pen up event), the fist input text enclosed in the source text block is inserted at the insertion position of the second input text.

In a block resizing step S460, the computing device DV resizes the target text block to enclose (or comprise, or accommodate) the merged input text (i.e. the second input text and the inserted first input text) within said target text block. In response to the insertion of the first input, the size of the target text block may be adjusted to the merged input text, for instance by increasing said current block in a first resizing orientation. In a particular example, the resizing may also lead to text reflow of the merged input text in target text block. Additionally, the insertion of the first input causes re-recognition of the merged input text within said target text block. The merged input text of the target block redefines the linguistic context which may modify the probabilistic scores of the word candidates processed during the re-recognition. The re-recognized merged input text may result in different converted outcomes compared to the recognized first and second input text which would be converted and copied along each other. The accuracy of the re-recognition is improved by allowing each fragmented input text to be efficiently merged and by recovering a more representative linguistic context.

Rearranging text block sections of handwriting input text allows improved processing of the input text handwriting recognition.

In a block deleting step module S470, the computing device DV may delete the source text block in response to the insertion of the first input text within the second input text in the target text block. The source text block is merged with the target text block.

1. A computer implemented method for merging, on a display, a source block into a target block, comprising:
displaying, on the display, the source block enclosing a first input text and the target block enclosing a second input text;
detecting, with an input interface, a user selection gesture for selecting the source block;
detecting, with the input interface, a user dragging gesture for moving the source block over the target block;
displaying a cursor in the source block according to an insertion dropping mode;
detecting an insertion position in the second input text indicated by the cursor of the source block according to the user dragging gesture;
inserting the first input text in the second input text at the insertion position; and
resizing the target block to enclose the second input text and the inserted first input text.

2. A method of claim 1 comprising:
extracting the source block from a first group of handwritten input strokes, the source block enclosing the first input text; and
recognizing the first input text.

3. A method of claim 2, comprising:
extracting the target block from a second group of handwritten input strokes, the target block enclosing the second input text; and
recognizing the second input text.

4. A method of claim 3 comprising:
re-recognizing the first and second input text enclosed in the target block after said inserting;

5. A method of claim 1, wherein the first input text and the second input text are converted as typeset.

6. A method of claim 5, wherein the inserting of the first input text in the second input text generates a merged input text displayed as a mixture of handwritten and typeset text.

7. A method of claim 1, wherein said method comprises switching to the insertion dropping mode in response to the user dragging gesture, wherein said switching includes redisplaying the source text block according to a predefined visual representation.

8. A method of claim 7, wherein the predefined visual representation comprises a predefined size of the source block.

9. A method of claim 1, wherein the user selection gesture for selecting the source block is detected in response to detecting a selection area which is defined as enclosing at least one input element of an initial text block; whereby:
the first input text comprises the enclosed at least one input element; and
the source block comprises a portion of the initial text block, said portion comprising said enclosed at least one input element.

10. A method of claim 2, wherein the source block and the target block are obtained by performing text block extraction from the first group and the second group of handwritten input strokes respectively, said block extraction comprising identifying text and non-text strokes and grouping the text strokes into the source block and the target.

11. A computer program comprising instructions which, when executed by one or more processors, causes the one or more processors to carry out a method according to claim 1.

12. A computing device for merging a source block into a target block comprising:
a display area configured to display the source block enclosing a first input text and the target block enclosing a second input text;
an input area configured to detect:
a user selection gesture for selecting the source block; and
a user dragging gesture for moving the source block over the target block;
a block selection module configured to select the source block;
a block moving module configured to move the source block;
a mode switching module configured to display a cursor in the source block according to an insertion dropping mode;
an insertion detection module configured to detect an insertion position in the second input text indicated by the cursor of the source block according to the user dragging gesture; and
a block resizing module configured to resize the target block to enclose the second input text and the inserted first input text.
